(19) United States
(12) Patent Application Publication
(10) Pub. No.: US 2025/0363426 A1
(43) Pub. Date: Nov. 27, 2025

(54) SECURE DATA DESTRUCTION AND TRANSFER SYSTEM WITH ENHANCED AGENT ENCLAVE FOR SAFEGUARDING STORED DECISIONS AND INFERENCES AND METHOD THEREOF

(71) Applicant: Affle (India) Limited, India, Gurugram (IN)

(72) Inventors: Anuj Khanna SOHUM, Singapore (SG); Charles Yong Jien FOONG, Templestowe (AU); Madhusudana RAMAKRISHNA, Singapore (SG)

(73) Assignee: Affle (India) Limited, India, Gurugram (IN)

(21) Appl. No.: 19/216,062

(22) Filed: May 22, 2025

(30) Foreign Application Priority Data
May 22, 2024 (IN) 202311079236

(51) Int. Cl. G06N 20/20; H04L 9/32

(52) U.S. Cl. CPC G06N 20/20; H04L 9/3236; H04L 9/3247

(57) ABSTRACT

A method for a secure data destruction and transfer is disclosed. The method includes selecting one or more Machine Learning (ML) models amongst and data associated with the one or more ML models to be destroyed. The one or more ML models and the data is stored in a data store. The method includes destroying the one or more ML models and the data associated with the one or more ML models from the datastore. The method includes verifying a destruction of the one or more ML models and the data. The method includes notifying one or more coordinators about the destruction of one or more ML models and the data. The method includes adjusting one or more data processing tasks performed by the one or more ML models to accommodate an absence of the one or more ML models and the data.

### CROSS-REFERENCE TO RELATED APPLICATIONS

This patent application claims priority to Indian Patent Application No. IN 202311079236, filed May 22, 2024, entitled “SECURE DATA DESTRUCTION AND TRANSFER SYSTEM WITH ENHANCED AGENT ENCLAVE FOR SAFEGUARDING STORED DECISIONS AND INFERENCES AND METHOD THEREOF,” and assigned to the assignee hereof. The disclosure of the prior application is considered part of and is incorporated by reference in this patent application.

### TECHNICAL FIELD

Embodiments of the present disclosure generally relate to data management systems and more particularly to secure data destruction and transfer systems with enhanced agent enclave for safeguarding stored decisions and inferences and methods thereof.

### BACKGROUND

In the digital age, management of sensitive data has become a paramount concern. Various systems and methods have been developed to handle data, including personally identifiable information (PII) and user preferences, in a secure and compliant manner. However, existing solutions often lack the flexibility and comprehensiveness to accommodate the evolving needs of modern data management systems. Existing systems primarily focus on the protection and storage of the PII, often neglecting the importance of handling inferences and decisions derived from data analytics. These systems also tend to have limited capabilities for the secure destruction of data when it is no longer needed, as well as preventing data leakage outside of the system.

Data leakage poses a significant risk, particularly in cases involving confidential information, proprietary data, and user preferences. The inadvertent transmission of sensitive data can lead to data breaches, legal liabilities, and damage to an organization's reputation. Existing systems do not adequately address these concerns, necessitating the development of an innovative and more comprehensive data management system.

Consequently, there is a need for improved secure data destruction and transfer systems with enhanced agent enclave for safeguarding stored decisions and inferences and methods thereof, to address at least the aforementioned issues of the prior arts.

### OBJECTS OF THE INVENTION

A general objective of the present disclosure is to provide a system and a method for a secure data destruction and transfer. The further objectives of present disclosure are discussed below.

Another objective of the present disclosure is to provide a system configured to destroy one or more Machine Learning (ML) and data of the one or more ML models upon being instructed that data is not needed, a consent of the data to store has expired.

Another objective of the present disclosure is to provide a system that destroys the data upon being notified about a security measure that requires a removal of the data.

Another objective of the present disclosure is to provide a system that redistributes tasks to accommodate an absence of the one or more ML models and the data.

### SUMMARY OF THE INVENTION

Solution to one or more drawbacks of existing technology, and additional advantages are provided through the present subject matter. Additional features and advantages are realized through the technicalities of the present subject matter. Other embodiments and aspects of the subject matter are described in detail herein and are considered to be a part of the claimed subject matter.

In an embodiment, the present invention discloses a method for a secure data destruction and transfer. The method includes selecting, by a destroy AI agent, one or more Machine Learning (ML) models amongst a plurality of ML models and data associated with the one or more ML models to be destroyed. The one or more ML models and the data is stored in a data store. The method includes destroying, by the destroy AI agent, the one or more ML models and the data associated with the one or more ML models from the datastore. The method includes verifying, by the destroy AI agent, a destruction of the one or more ML models and the data. The method includes notifying, by the destroy AI agent, one or more coordinators about the destruction of one or more ML models and the data. The method includes adjusting, by the one or more coordinators, one or more data processing tasks performed by the one or more ML models to accommodate an absence of the one or more ML models and the data. Remaining data associated with the one or more data processing tasks is transmitted to one or more available data processing agents for performing the one or more data processing tasks.

In an embodiment, the present invention discloses a system for a secure data destruction and transfer. The system includes a destroy AI agent configured to select one or more Machine Learning (ML) models amongst a plurality of ML models and data associated with the one or more ML models to be destroyed. The one or more ML models and the data is stored in a data store. The a destroy AI agent is configured to destroy the one or more ML models and the data associated with the one or more ML models from the datastore. The destroy AI agent is configured to verify a destruction of the one or more ML models and the data. The destroy AI agent is configured to notify one or more coordinators about the destruction of one or more ML models and the data. The one or more coordinators is configured to adjust one or more data processing tasks performed by the one or more ML models to accommodate an absence of the one or more ML models and the data. Remaining data associated with the one or more data processing tasks is transmitted to one or more available data processing agents for performing the one or more data processing tasks

### BRIEF DESCRIPTION OF THE DRAWINGS

The disclosure will be described and explained with additional specificity and detail with the accompanying figures in which:

FIG. 1 illustrates an exemplary block diagram representation of a network architecture implementing a secure data destruction and transfer system with enhanced agent enclave for safeguarding stored decisions and inferences, in accordance with an embodiment of the present disclosure;

FIG. 2 illustrates an exemplary block diagram representation of a computer implemented system, such as those shown in FIG. 1, capable of secure data destruction and transfer with enhanced agent enclave for safeguarding stored decisions and inferences, in accordance with an embodiment of the present disclosure; and

FIG. 3 illustrates an exemplary flow diagram representation of interaction between destroy AI agent, datastore, coordinators, and data processing agents, in accordance with an embodiment of the present disclosure; and

FIG. 4 illustrates an operational flow diagram depicting a process for a secure data destruction and transfer, in accordance with an embodiment of the present disclosure.

Further, those skilled in the art will appreciate that elements in the figures are illustrated for simplicity and may not have necessarily been drawn to scale.

Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

Embodiments of the present disclosure provide secure data destruction and transfer systems with enhanced agent enclave for safeguarding stored decisions and inferences and methods thereof.

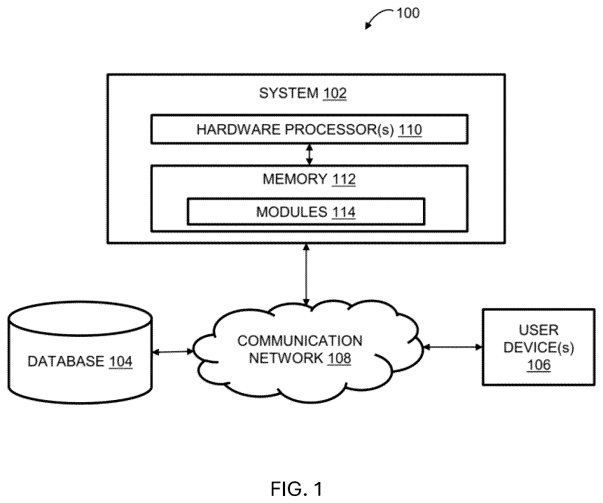

Referring now to the drawings, and more particularly to FIG. 1 through FIG. 3, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture 100 implementing secure data destruction and transfer systems with enhanced agent enclave for safeguarding stored decisions and inferences, in accordance with an embodiment of the present disclosure. According to FIG. 1, the network architecture 100 includes the system 102, a database 104, and one or more user devices 106. The one or more user devices 106 may be associated with one or more users, and communicatively coupled to the system 102 via a communication network 108. In an exemplary embodiment of the present disclosure, the user devices 106 may include a laptop computer, desktop computer, tablet computer, smartphone, wearable device, a digital camera, and the like. Further, the communication network 108 may be a wired network or a wireless network. The system 102 may be at least one of, but not limited to, a central server, a cloud server, a remote server, an electronic device, a portable device, and the like. Further, the system 102 may be communicatively coupled to the database 104, via the communication network 108. The database 104 may include, but is not limited to, model data, destruction confirmation data, notification data, data handling meta data, secure agent enclave data, personal identifiable information (PII) data, preferences data, decisions data, inferences data, any other data, and combinations thereof. The database 104 may be any kind of databases/repositories such as, but are not limited to, relational database, dedicated database, dynamic database, monetized database, scalable database, cloud database, distributed database, any other database, and combination thereof.

Further, the user device 106 may be associated with, but not limited to, a user, an individual, an administrator, a vendor, a technician, a worker, a specialist, a healthcare worker, an instructor, a supervisor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like. The user device 106 may be used to provide input and/or receive output to/from the system 102, and/or to the database 104, respectively. The user device 106 may present to the user one or more user interfaces for the user to interact with the system 102 and/or to the database 104 for secure data destruction and transfer with enhanced agent enclave for safeguarding stored decisions and inferences need. The user device 106 may be at least one of, an electrical, an electronic, an electromechanical, and a computing device. The user device 106 may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Further, the system 102 may be implemented by way of a single device or a combination of multiple devices that may be operatively connected or networked together. The system 102 may be implemented in hardware or a suitable combination of hardware and software. The system 102 includes one or more hardware processor(s) 110, and a memory 112. The memory 112 may include a plurality of modules 114. The system 102 may be a hardware device including the hardware processor 110 executing machine-readable program instructions for secure data destruction and transfer systems with enhanced agent enclave for safeguarding stored decisions and inferences and methods thereof. Execution of the machine-readable program instructions by the hardware processor 110 may enable the proposed system 102 to secure data destruction and transfer with enhanced agent enclave for safeguarding stored decisions and inferences. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, hardware processor 110 may fetch and execute computer-readable instructions in the memory 112 operationally coupled with the system 102 for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, sensors, any other devices, and combination thereof. The person skilled in the art should not be limiting the components/subsystems shown in FIG. 1. Although FIG. 1 illustrates the system 102, and the user device 106 connected to the database 104, one skilled in the art can envision that the system 102, and the user device 106 can be connected to several user devices located at various locations and several databases via the communication network 108.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure is depicted and described. The remainder of the construction and operation of the system 102 may conform to any of the various current implementations and practices that were known in the art.

In an exemplary embodiment, the system 102 may securely destroy a model within an environment to ensure the secure deletion of stored data and verifying its non-existence within the environment. In an exemplary embodiment, the system 102 may notify coordinators and manage upstream and downstream data processing to maintain system functionality even after model destruction.

In an exemplary embodiment, the system 102 may validate the secure destruction of data. In an exemplary embodiment, the system 102 may confirm that data no longer exists in the environment after being deleted, ensuring data integrity and compliance.

In an exemplary embodiment, the system 102 may provide a secure agent enclave as a fundamental embodiment, which restricts data transmission solely to authorized entities, such as coordinators and modules, preventing unauthorized data leakage outside the environment. This enclave's security may be enhanced through specific hardware-based security features (such as Intel SGX, AMD SEV) to create isolated execution environments for the AI agents, particularly the destroy AI Agent 302 and the one or more coordinators 304-1, ensuring that even privileged system administrators cannot access or tamper with the agent's code or data in memory. Secure communication channels within the enclave between agents could use short-lived, mutually authenticated sessions, with policies strictly enforced by the one or more coordinators 304-1 at every interaction point. The enclave may also feature robust intrusion detection and response mechanisms specifically tailored to AI agent behaviour to protect the very agents that implement these advanced privacy and data management features. In an exemplary embodiment, the system 102 may handle a variety of data types, including but not limited to Personally Identifiable Information (PII), user preferences, decisions, and inferences. The system 102 integrates all these data types, offering a comprehensive solution for data management and security.

In an exemplary embodiment, the system 102 may provide a data management architecture that combines the management of personally identifiable information (PII), preferences, decisions, and inferences within a single system, thus introducing a groundbreaking approach to data handling and security.

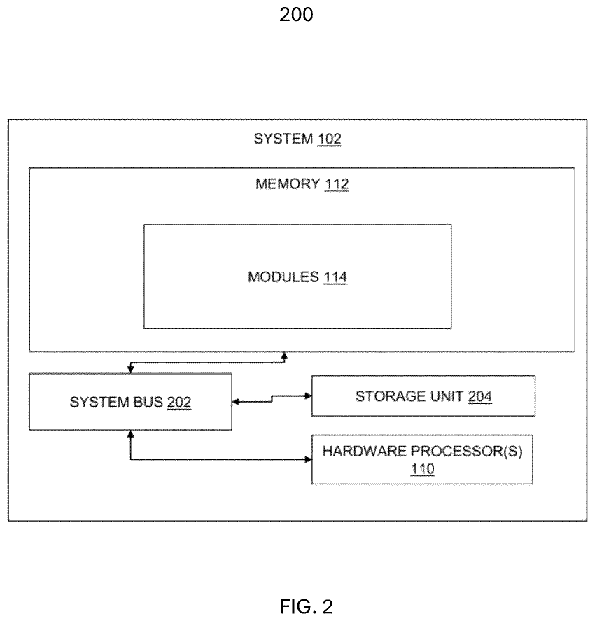

FIG. 2 illustrates an exemplary block diagram representation 200 of a computer implemented system 102, such as those shown in FIG. 1, capable of secure data destruction and transfer with enhanced agent enclave for safeguarding stored decisions and inferences, in accordance with an embodiment of the present disclosure. The system 102 may also function as a computer-implemented system/server (hereinafter referred to as the system 102). The system 102 comprises the one or more hardware processors 110, the memory 112, and a storage unit 204. The one or more hardware processors 110, the memory 112, and the storage unit 204 are communicatively coupled through a system bus 202 or any similar mechanism. The memory 112 comprises a plurality of modules 114 in the form of programmable instructions executable by the one or more hardware processors 110.

The one or more hardware processors 110, as used herein, means any type of computational circuit, such as, but not limited to, a microprocessor unit, microcontroller, complex instruction set computing exceptionally long processor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory 112 may be a non-transitory volatile memory and a non-volatile memory. The memory 112 may be coupled to communicate with the one or more hardware processors 110, such as being a computer-readable storage medium. The one or more hardware processors 110 may execute machine-readable instructions and/or source code stored in the memory 112. A variety of machine-readable instructions may be stored in and accessed from the memory 112. The memory 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 112 includes the plurality of modules 114 stored in the form of machine-readable instructions on any of the above-mentioned storage media and may be in communication with and executed by the one or more hardware processors 110.

The storage unit 204 may be a cloud storage or a repository such as those shown in FIG. 1. The storage unit 204 may store, but is not limited to, model data, destruction confirmation data, notification data, data handling meta data, secure agent enclave data, personal identifiable information (PII) data, preferences data, decisions data, inferences data, any other data, and combinations thereof. The storage unit 204 may be any kind of databases/repositories such as, but are not limited to, relational database, dedicated database, dynamic database, monetized database, scalable database, cloud database, distributed database, any other database, and combination thereof.

In an exemplary embodiment, the plurality of modules 114 may securely destroy a model within the environment to ensure the secure deletion of stored data and verifying its non-existence within the environment. In an exemplary embodiment, the system 102 may notify coordinators and manage upstream and downstream data processing to maintain system functionality even after model destruction.

In an exemplary embodiment, the plurality of modules 114 may validate the secure destruction of data. In an exemplary embodiment, the system 102 may confirm that data no longer exists in the environment after being deleted, ensuring data integrity and compliance.

In an exemplary embodiment, the plurality of modules 114 may provide a secure agent enclave as a fundamental embodiment, which restricts data transmission solely to authorized entities, such as coordinators and modules, preventing unauthorized data leakage outside the environment.

In an exemplary embodiment, the plurality of modules 114 may handle a variety of data types, including but not limited to Personally Identifiable Information (PII), user preferences, decisions, and inferences. The system 102 integrates all these data types, offering a comprehensive solution for data management and security.

In an exemplary embodiment, the plurality of modules 114 may provide a data management architecture that combines the management of personally identifiable information (PII), preferences, decisions, and inferences within a single system, thus introducing a groundbreaking approach to data handling and security.

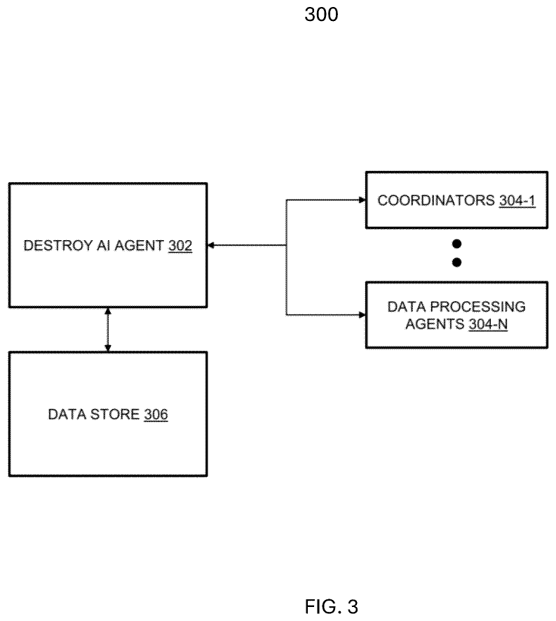

FIG. 3 illustrates an exemplary flow diagram representation 300 of interaction between destroy AI agent, datastore, coordinators, and data processing agents, in accordance with an embodiment of the present disclosure. The destroy AI agent 302 may be responsible for securely destroying machine learning models and associated data within the environment. This action is initiated when certain data is no longer needed or when security measures require data removal. The coordinators 304-1 may serve as entities that oversee and manage data processes within the environment. The one or more coordinators 304-1 function as intelligent policy decision and enforcement points, continuously interpreting a set of declarative policies related to privacy, security, data sharing, agent interaction, and lifecycle management. When an event occurs (e.g., new consent, reputation change from the marketplace, destruction request, data access attempt), the one or more coordinators 304-1 evaluate the relevant policies in real-time. Based on this evaluation, the one or more coordinators 304-1 dynamically issue commands to other agents (the one or more available data processing agents 304-N, the destroy AI Agent 302), reconfigure access permissions to the Datastore 306, or trigger specific data transformation processes like obfuscation levels based on reputation, potentially utilizing a rules engine and an event-driven architecture. The coordinators 304-1 may play a crucial role in ensuring the proper flow of data and the coordination of activities involving data. Further, the data processing agents 304-N may be responsible for executing data processing tasks within the environment. These tasks can include data analysis, inference generation, and other data-related operations. Additionally, the datastore 306 may be a central component for storing data, including machine learning models and related data, within the environment. The datastore 306 may hold a repository of data that may be subject to destruction by the destroy AI agent 302.

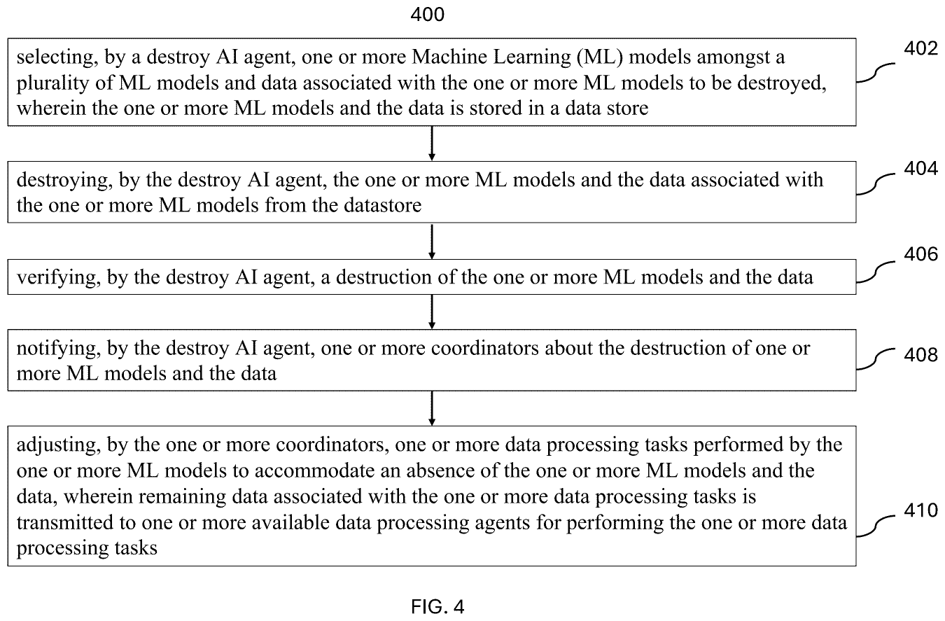

FIG. 4 illustrates an operational flow diagram depicting a method 400 for a secure data destruction and transfer, in accordance with an embodiment of the present disclosure. The method 400 is implemented by the system 102. The system 102 provides a secure and dynamically managed cloud-based enclave, as depicted in FIG. 3, distinguished by a comprehensive data lifecycle management, fine-grained temporal data tracking for complete decision traceability, and an innovative agent reputation system that governs data sharing.

At step 402, the method 400 includes selecting, by a destroy AI agent 302, one or more Machine Learning (ML) models amongst a plurality of ML models and data associated with the one or more ML models to be destroyed. The one or more ML models and the data is stored in a data store. The data may include raw data, Personally Identifiable Information (PII) associated with a user interacting with the one or more ML models, one or more user preferences associated with the user, one or more decisions derived by the one or more ML models while interacting with the user, one or more conclusion of the interaction of the user with the one or more ML models, one or more inferences generated based on the interaction of the user with the one or more ML models, behavior of an AI agent interacting with the user, access patterns, and performance metrics of the one or more ML models. Selecting that the one or more ML models and the data associated with the one or more ML models to be deleted is based on receiving, by the destroy AI agent 302, an instruction to delete at least one ML model amongst the plurality of ML models and data associated with the at least one ML model. The instruction is received from one of a hardware processor based on a predefined data retention policy and consent expirations, and a user. Selecting the one or more ML models also includes ascertaining, by the destroy AI agent 302, one or more of that the one or more ML models and the data is not further needed, one or more security measures require a removal of the one or more ML models and the data, and an expiry of a consent to store the data.

At step 404, the method 400 includes destroying, by the destroy AI agent 302, the one or more ML models and the data associated with the one or more ML models from the datastore 306. Destroying the one or more ML models and the data includes performing one or more of deleting the one or more ML models and the data, and rendering the one or more ML models and the data inaccessible. To that understanding, upon a destruction of the one or more ML models and the data, the method 400 includes generating, by the destroy AI agent 302, a cryptographically verifiable proof of destruction upon destroying the one or more ML models and the data. The cryptographically verifiable proof of destruction includes a detailed manifest of each targeted data object identifier. Each targeted data object identifier is one of specific temporal data slices, model segments, and lineage links related to the deleted agent/data). Upon generating the cryptographically verifiable proof of destruction, the method 400 includes cryptographically hashing, by the destroy AI agent, the manifest to generate a hash, wherein the hash comprises a timestamp from a secure time source and a digital signature of the Destroy AI Agent 302 a manifest of targeted data categories and identifiers, a timestamp associated with the destruction and verification of the destruction of the data, a confirmation of a destruction method deployed. The hash is generated using SHA-256 or a more advanced technique. The hash, along with the timestamp from the secure time source and the digital signature of the Destroy AI Agent 302 itself (using its unique private key), forms a core of the proof. Furthermore, the proof may be anchored to a permissioned blockchain or an immutable ledger accessible for audit, making any tampering evident and ensuring its non-repudiable guarantee of destruction. The method 400 further includes logging, by the destroy AI agent 302, the cryptographically verifiable proof of destruction securely

Furthermore, the destroy AI agent (302) acts upon data, the system 102 might need to consider implications for one or more descendant agents if destroyed knowledge is foundational for the one or more descendent agents. Policies might need to define how to handle such scenarios (e.g., notify owners of descendant agents, trigger retraining, or mark descendant knowledge components as potentially compromised or outdated). The proof of destruction might also need to reference any known descendant impacts.

At step 406, the method 400 includes verifying, by the destroy AI agent 302, a destruction of the one or more ML models and the data.

At step 408, the method 400 includes notifying, by the destroy AI agent 302, one or more coordinators 304-1 about the destruction of one or more ML models and the data.

At step 410, the method 400 includes adjusting, by the one or more coordinators 304-1, one or more data processing tasks performed by the one or more ML models to accommodate an absence of the one or more ML models and the data. Remaining data associated with the one or more data processing tasks is transmitted to one or more available data processing agents 304-N for performing the one or more data processing tasks. The one or more available data processing agents 304-N is configured to execute one or more data processing tasks comprising a data analysis, an inference generation, and one or more other data-related operations. Adjusting the one or more data processing tasks includes performing one or more of redistributing the one or more data processing tasks amongst the one or more available data processing agents 304-N based on a reputation score fetched from one of an internal registry, and a federated marketplace, associated with the one or more available data processing agents 304-N, and recalibrating data analyzing processes based on available data. The one or more coordinators 304-1 requests one of the federated market place and the internal registry the reputation score before sanctioning a data exchange between data processing agents or with external entities. The remaining data associated with the one or more data processing tasks is obfuscated before being redistributed among the one or more data processing agents. The reputation-sensitive data obfuscation may be operationalized when a coordinator 304-1 instructs a specialized ‘Data Transformation Service’ (which could be a type of Data Processing Agent) or invokes capabilities within the datastore (306) interface. The service would apply specific obfuscation techniques. Examples of the specific obfuscation techniques include, but are not limited to, k-anonymization, l-diversity, differential privacy mechanisms, generalization, noise injection. Parameters of the specific obfuscation techniques (e.g., the ‘k’ in k-anonymization, the ‘epsilon’ in differential privacy, the level of noise) are directly derived from the requesting agent's reputation score or category. The protocol for communicating the data and the required obfuscation level would be managed by the one or more coordinator 304-1. Further, the one or more available data processing agents 304-N operate on data (base, inferred, behavioral) retrieved from the Datastore. An access and ability of the one or more available data processing agents 304-N to process or share data may be dynamically adjusted by the one or more coordinators 204-1 based on sensitivity of information and a reputation of one or more available data processing agents 304-N. While standard secure protocols (e.g., mTLS) form a baseline, an application layer protocol must carry agent reputation tokens or allow for dynamic policy checks based on reputation scores during session establishment or data request. To support dynamic, reputation-based data sharing, APIs and communication protocols should also support parameters or headers that allow the one or more coordinators 304-1 or mediating agents to instruct on the level of obfuscation required for data being transmitted to less trusted agents. For comprehensive auditability and compliance, protocols for securely streaming audit logs including consent records, access patterns, sharing decisions (and their trust-based rationale), proofs of destruction, and lineage records to a dedicated, immutable audit trail are essential. Furthermore, in ecosystems involving an agent marketplace, standardized protocols are required for agents to securely register, publish their capabilities and reputation, and be discovered by other agents. In an embodiment of the present disclosure, the method 400 also includes restricting, by the destroy AI agent 302, a transmission of the remaining data to the one or more authorized entities, wherein the one or more authorized entities comprises the one or more coordinators 304-1, upstream processors, and downstream processors. Furthermore, the datastore 306 is configured to timestamp the data and generate a linkage between slices of the data linking the slices with each of the ML models responsible for generation of the slice of the data. To maintain the integrity of temporal sequences and multi-generational knowledge lineage, the datastore 306 may be architected using principles of event sourcing, where every change (data creation, modification, inference generation, agent interaction, knowledge transfer, consent update, destruction event) is recorded as an immutable, time-stamped event, creating an indelible audit trail. For lineage tracking, it might employ graph database-like structures or specific metadata linking schemas that explicitly map parent-child agent relationships and the flow of specific knowledge components across these generations. Querying this datastore involves reconstructing states at specific points in time or traversing these event/lineage graphs. The linkage may establish and maintain a traceable lineage of knowledge (including models, datasets, specific learned parameters, or significant inferences) as it is utilized, transferred, or inherited between a parent AI agent and its descendant AI agents (e.g., child agents created from the parent agents trained using the parent's knowledge, or agents that incorporate models/modules from the parent).

The above mentioned tracking mechanism involves recording linkage information within the datastore 306 or a related auditable system, explicitly connecting knowledge components in a descendant agent back to a source in an ancestor agent. The system 102 provides a capability to query and visualize this inter-generational knowledge flow, allowing users or auditors to understand how foundational knowledge or specific traits have propagated, evolved, or been diluted across a family of related AI agents. The linkage would also be temporal, indicating when knowledge transfer or inheritance occurred. The act of an agent creating, training, or fine-tuning a ‘descendant’ agent and passing knowledge is a formalized, recorded process. This involves a defined protocol where a parent agent registers its intent to create a child or transfer a specific knowledge component (e.g., a trained model layer, a dataset fingerprint, a set of learned parameters). The one or more coordinators 304-1 play a critical role in managing these inter-agent relationships, potentially mediating this knowledge transfer process, verifying permissions, and overseeing the registration of agent ‘parentage’. Upon successful transfer, a detailed lineage record is created in the datastore 306, capturing: IDs of parent and child agents, ID/version of the knowledge component, a hash/fingerprint of the component, timestamp, and the purpose/context of the transfer, ensuring an auditable chain of provenance. The system 102 provides a capability to query and visualize this inter-generational knowledge flow, allowing users or auditors to understand how foundational knowledge or specific traits have propagated. Furthermore, the reputation of an ancestor agent could influence the initial baseline reputation of its descendants, and the transparency offered by this knowledge lineage tracking could itself become a factor in an agent's reputation, with agents having clear, auditable knowledge ancestries potentially being deemed more trustworthy.

Furthermore, Timestamping the data may create an immutable chronological record that enables unprecedented traceability of how any piece of information (original, inferred, or behavioral) contributed to, or is affected by, subsequent decisions or data modifications.

Each of raw data, the PII associated with a user interacting with the one or more ML models, the one or more user preferences associated with the user, the one or more decisions derived by the one or more ML models while interacting with the user, the one or more conclusion of the interaction of the user with the one or more ML models, the one or more inferences generated based on the interaction of the user with the one or more ML models, the behavior of an AI agent interacting with the user, the access patterns, and the performance metrics of the one or more ML models forming the data may be timestamped. The data may be reconstructed at any specific point in time to trace an origin and contributing factors of any decision or inference made by the system (e.g., by the one or more available data processing agents 304-N or one of more ML models.

In an embodiment of the present disclosure, the data may enter the datastore 306, which preceded by a robust consent mechanism, where terms of use, data storage duration, purposes of processing, and potential sharing are clearly defined and agreed upon. Consent parameters are stored alongside the data. The one or more available data processing agents 304-N under a direction of the one or more coordinators 304-1 accesses the timestamped data. New inferences and behavioral data generated may also be time-stamped and stored, maintaining a chronological integrity of the data.

Moving forward, authorized entities (e.g., administrators, auditors, or specialized system agents) may query the system 102 to trace a lineage of any decision. The system 102 may reconstruct a state of all relevant information (base, inferred, behavioral) at any given point in time, showing exact data points that led to a particular outcome.

Furthermore, in an exemplary embodiment, an agent (internal or discovered via a marketplace) requests information from the one or more available data processing agents (304-N) or directly from the datastore (306) via the one or more Coordinator (304-1). The one or more Coordinator 304-1 assesses the trustworthiness/reputation of the requesting agent. The reputation might be derived from a shared ledger, historical interaction analysis, or a central agent registry within the broader patent ecosystem. Based on the reputation score and the data's sensitivity, full access may be granted, data may be obfuscated (e.g., anonymized, generalized, or perturbed with noise) before sharing with less trusted agents, or access may be denied entirely if the trust threshold is not met.

### Exemplary Interaction Process Between Destroy AI Agent, Datastore, Coordinators. and Data Processing Agents:

For example, the destroy AI agent 302 may identify specific machine learning models or related data within the datastore 306 that need to be securely destroyed. Upon identification, the destroy AI agent 302 initiates the destruction process, which may include deleting or rendering the data inaccessible. Simultaneously, the destroy AI agent 302 notifies the coordinators 304-1 about the destruction activity. This notification ensures that the coordinators 304-1 are aware of the changes in the environment.

The coordinators 304-1 may then initiate coordination activities to adjust data processing tasks to accommodate the absence of the destroyed models or data. This might involve redistributing data processing tasks among available data processing agents 304-N or recalibrating data analysis processes. When the destroy AI agent 302 notifies the coordinators 304-1 of the destruction, the coordinators can reassign or reconfigure data processing tasks to ensure that the system continues to function effectively even after the destruction of models or data. This reconfiguration may involve re-routing data processing tasks to different data processing agents 304-N or recalibrating data analysis processes based on the available data.

In an embodiment, the information will follow privacy policies and user permissions. that may limit the usage for a particular period, purpose, or limit the engagement between agents. These rules can be in the form of a list of allowed and prohibited keywords, data, subset of agents, categories, classifications.

In an embodiment, the lifecycle of these should also be managed, and learnings during shared engagements should also be allowed to train user models. For example, if a celebrity/company shares a model for advertisement purposes, any engagements can be used to train their own systems. After the engagement in this case for advertisement then the data for the engagement which could be models should be destroyed.

### Exemplary Scenario 1:

Consider, an enhanced data security and efficiency to be provided for a financial institution. For example, the organization has implemented an innovative data management system that combines secure data destruction, notification mechanisms, an Agent enclave, and comprehensive data handling, ensuring the safeguarding of personally identifiable information (PII), preferences, decisions, and inferences. In a data clean-up process, the financial institution periodically conducts data clean-up procedures to ensure the removal of outdated and unnecessary data, which may include historical customer records, transaction logs, and customer preferences. As part of this data clean-up process, the destroy AI agent 302 is activated to securely destroy obsolete machine learning models and associated data that are no longer relevant to the institution's operations.

The destroy AI agent 302 ensures that the data is completely destroyed and that there are no remnants left within the system. This validation process involves confirming the data's non-existence in the datastore 306. Simultaneously, the destroy AI agent 302 sends notifications to the coordinators 304-1. The coordinators 304-1 oversee data processes and ensure seamless operation. The coordinators 304-1 are promptly informed of the data destruction activities and are prepared to take action. Upon receiving the notification, the coordinators 304-1 take immediate steps to ensure the continuity of data processes. They redistribute data processing tasks among data processing agents 304-N to accommodate the removal of the obsolete data. The data processing agents 304-N adapt to the changes and efficiently process data without interruption. They are equipped to handle the evolving data landscape, utilizing the institution's latest machine learning models and up-to-date customer information. The secure agent enclave actively ensures that data is not leaked outside the system. It restricts data transmission to authorized entities only, including the coordinators 304-1 and upstream and downstream data processors.

### Exemplary Scenario 2;

Consider, in a large healthcare organization, a highly advanced data management system is employed to process and analyze patient data, diagnoses, and predictive analytics. This system heavily relies on machine learning models to make predictions about patient outcomes based on historical data. To ensure data security and integrity, the organization has introduced the destroy AI agent 302 as a vital component, working in conjunction with the datastore 306, coordinators 304-1, and a network of data processing agents 304-N. For example, the healthcare organization decides to enhance its predictive models by updating them to reflect the most current medical knowledge and to improve prediction accuracy. This process results in the older machine learning models becoming obsolete and necessitates their secure removal.

The process commences with the destroy AI agent 302 receiving instructions to securely delete the outdated machine learning models. The agent efficiently identifies the specific models within the datastore 306 that are no longer in use and are due for elimination. Once identified, the destroy AI agent 302 proceeds to initiate the secure data destruction process within the datastore 306. Its objective is to ensure that there is no trace of the outdated models and associated data left within the environment. Simultaneously, the destroy AI agent 302 sends out a notification to the coordinators 304-1. This notification serves as an alert, informing the coordinators about the data destruction activities that are currently in progress. It effectively communicates that specific machine learning models are no longer available for data processing and analysis.

In response to this notification, the coordinators 304-1 take immediate action. Their role is crucial in orchestrating the realignment of data processing tasks to accommodate the absence of the outdated machine learning models. They are responsible for ensuring that the system continues to provide accurate predictions, employing the newly updated models and data. This adaptation process involves close collaboration between the coordinators 304-1 and the network of data processing agents 304-N. Together, they recalibrate the data processing agents 304-N, reconfiguring them to utilize the latest machine learning models and the most current patient data. The objective is to ensure that patient data is analyzed, and predictions are made using the latest, most accurate information available.

### Exemplary Scenario 3:

Consider a celebrity licensing their AI agent for a limited-time advertising campaign. The celebrity's agent provides consent for its likeness, behavioral patterns (temporarily learned or baseline), and specific inferences to be used for the campaign, for a defined duration (e.g., 3 months). The information is logged in the datastore 306 with timestamps. The ad campaign runs and the celebrity's AI agent (a Data Processing Agent 304-N) interacts with users. All interactions, user responses (behavioral data), and any new inferences specific to the campaign are stored in the datastore 306, time-stamped. Based on a mid-campaign analytics and sharing, an analytics agent (another data processing agent 304-N) requests campaign performance data. The one or more coordinators 304-1 verifies the analytics agent's reputation. If high, full data is shared. If it's a third-party analytics agent with a moderate reputation, the Coordinator might instruct for PII to be obfuscated before sharing. If an ad is unexpectedly successful or unsuccessful, marketers may use the temporal traceability feature to see exactly which user behaviours, agent inferences, or base data points (all time-stamped) correlated with that outcome. Upon an end of the campaign, after few month, the destroy AI agent 302 flags the campaign-specific data (celebrity's temporary behavioral adaptations, campaign-specific inferences, associated PII from interactions) for destruction as per the initial consent and duration. The agent securely destroys this data from the datastore 306) A proof of destruction is generated and logged, available to the celebrity's representatives. The one or more coordinators 304-1 ensure that no ongoing processes attempt to access this now-destroyed campaign data.

Exemplary scenario 4:

A user named Alex Deletes the “AppRec AI” Agent (with Enhanced Verification). The initial setup (User Alex, Agent R, Destroy AI Agent 302, Coordinator AI 304-1, Datastore 306, and their associated data/knowledge) remains the same as in the previous scenario. The “AppRec AI” Agent that has been providing personalized app recommendations, and Alex wants to understand how all associated information will be thoroughly destroyed. The scenario may emphasize the role of the destroy AI agent 302, the privacy lifecycle management (consent withdrawal leading to deletion), the comprehensive nature of data stored in datastore 306 (including agent models, inferences, behavioral data, and lineage), and the generation of verifiable proof of destruction.

In another scenario, Alex has been using a personalized “AppRec AI” (App Recommender AI) service within the app store for several months. Alex initially consented to this agent using their app usage history and preferences to provide tailored recommendations. A dedicated data processing agent 304-N, personalized for Alex. It might have its own fine-tuned model, a history of inferences it made about Alex's preferences, and behavioral data related to Alex's interactions with its recommendations. Agent R's Knowledge Lineage: Agent R, an agent of the “AppRec AI” that is to be deleted, might have been a child agent, initially cloned or fine-tuned from a more general Parent Recommendation Engine (Agent P) within the app store. It might not have any “child” agents itself, being a terminal agent in its lineage for Alex's specific use. The datastore 306 may securely stores Agent R's specific operational model(s) and configuration, Alex's base data used by Agent R (e.g., list of installed apps, app usage frequency, explicit likes/dislikes provided to Agent R), Inferences made by Agent R about Alex (e.g., “Alex prefers puzzle games with short session times,” “Alex is likely to try new indie RPGs”), behavioral data of Alex's interactions with Agent R's recommendations (e.g., apps Alex installed based on Agent R's suggestions, recommendations Alex dismissed), knowledge lineage records for Agent R (e.g., “Agent R (ID: AR456 for user Alex_ID123) was fine-tuned from Parent Recommendation Engine (ID: PR002) on Jan. 5, 2025, using Alex's initial preference set.”). Furthermore, for deletion, Alex navigates to the app store account settings and explicitly requests to “Delete AppRec AI (Agent R) and all its associated data.” This action signifies a withdrawal of consent for Agent R's operations. The request is received by the app store system. The one or more coordinators 304-1 authenticates Alex and validates the request. The one or more coordinator 304-1 tasks the destroy AI agent 302 with the complete and secure deletion of Agent R and all its uniquely associated data pertaining to Alex.

The Destroy AI Agent 302, in collaboration with the one or more coordinators 304-1, queries the datastore 306 to identify every piece of information linked to Agent R for user Alex. This includes:
Agent R's Instance: The specific software instance of Agent R, its configuration files, and any proprietary operational models developed or uniquely fine-tuned for Alex by Agent R.
Alex's Base Data Fed to Agent R: Any specific data points Alex provided directly to Agent R or that Agent R was uniquely permissioned to use from Alex's general profile (e.g., app install history, usage logs specifically for Agent R's analysis).
Inferences Generated by Agent R: All predictions, preference scores, or classifications about Alex that Agent R produced and stored (e.g., “Alex has a 75% probability of liking strategy game X”).
Behavioral Data with Agent R: Logs of Alex's interactions with Agent R's recommendations (clicks, installs from recommendations, dismissals, ratings provided on recommendations).
Knowledge Lineage Records of Agent R: The records detailing Agent R's own origin (e.g., its link to Agent P).

If Agent R's model was uniquely fine-tuned for Alex to the point it's distinct and contains Alex's data implicitly, that specific model instance is targeted for destruction. The generic knowledge or base model within Agent P (Parent Recommendation Engine) is not destroyed, as it serves other users and other child agents. However, the link in the lineage record showing Agent R inherited from Agent P is marked as severed or archived as part of Agent R's destruction. Any parameters or data derived from Alex's interaction that might have been back-propagated (with consent) from Agent R to specifically update only Alex's profile within Agent P would also be targeted if that consent is now revoked. The system 102 ensures that if any non-personal, anonymized insights derived from Agent R's operation (which would be rare for a purely personal agent without further explicit consent for such sharing) were permissibly used by other system-level agents, the raw data link to Alex via Agent R is severed. For a personal recommender, the primary goal is complete removal of Alex's data footprint associated with this agent. The destroy AI agent 302 executes secure deletion protocols on all identified data components for Agent R related to Alex within the datastore 306. The destroy AI agent 302 notifies the one or more coordinators 304-1 that the primary destruction commands have been executed. The one or more coordinator 304-1 initiates a series of automated verification routines. The tests are designed to confirm the absence and inaccessibility of Agent R and its associated data for Alex. The one or more coordinators 304-1 (or a designated verification sub-agent) attempts to directly query the datastore 306 for Agent R's specific model ID (previously associated with Alex), Alex's base data that is scoped to Agent R, and specific inferences Agent R had made for Alex (using their known identifiers from before deletion). Expected Outcome: “Not Found” errors, access denied flags, or empty result sets for all targeted items. The one or more coordinator 304-1 simulates an attempt by Alex's user device (or a system service acting on Alex's behalf) to make an API call to the endpoint previously used by Agent R to provide recommendations. The API may return a definitive error indicating the agent/service is no longer available for this user (e.g., HTTP 404 Not Found, HTTP 410 Gone, or a custom error code signifying “service decommissioned for user”). The response may not contain any old recommendations or default/generic data that might imply the agent is still partially active. If Agent R's recommendations are displayed in a specific section of an application store user interface for Alex, automated tests (or instructions for manual QA if needed for complex UIs) may verify that this section no longer attempts to load Agent R's content or gracefully indicates the service's removal. UI reflects the service's absence; no attempts to call Agent R's defunct endpoints.

The one or more coordinators 304-1 queries the datastore 306 to check the status of Agent R's lineage record. The record may be as “deleted,” “decommissioned,” or its links to Alex should be verifiably severed. The one or more coordinator 304-1 verifies that Agent R (for Alex) is no longer listed in any active agent registries or service discovery mechanisms that Alex's interactions would trigger. Agent R is not discoverable or listed as active for Alex. Based on successful verification tests, the one or more coordinator 304-1 confirms Agent R's de-provisioning. It ensures all related UI elements, service endpoints, and internal system references are definitively updated or disabled for Alex. It logs the successful outcome of all verification tests. The destroy AI agent 302, or the one or more coordinators 304-1 leveraging the Destroy AI Agent's initial report and the verification test results, generates an enhanced cryptographically verifiable proof of destruction. This proof now includes manifest of targeted data categories and identifiers. (Same as before), timestamps of primary destruction and verification phases, confirmation of destruction methods. (Same as before), a summary of the verification tests performed and their successful outcomes (e.g., “Datastore probe for Agent R model [ID: AR456_Alex_ID123_model]: Confirmed Not Found at [Timestamp]. API endpoint test for Agent R recommendations for Alex_ID123: Confirmed HTTP 410 response at [Timestamp].”), and cryptographic hash of the complete proof document.

For the sake of brevity, the construction, and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the hardware platform. As illustrated, the hardware platform may include additional components not shown, and some of the components described may be removed and/or modified. For example, a computer system with multiple GPUs may be located on external-cloud platforms including Amazon Web Services® (AWS), internal corporate cloud computing clusters, or organizational computing resources.

The hardware platform may be a computer system such as the system 102 that may be used with the embodiments described herein. The computer system may represent a computational platform that includes components that may be in a server or another computer system. The computer system may be executed by the processor (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor that executes software instructions or code stored on a non-transitory computer-readable storage medium to perform methods of the present disclosure. The software code includes, for example, instructions to gather data and analyze the data as the plurality of modules 114.

The instructions on the computer-readable storage medium are read and stored the instructions in storage or random-access memory (RAM). The storage may provide a space for keeping static data where at least some instructions could be stored for later execution. The stored instructions may be further compiled to generate other representations of the instructions and dynamically stored in the RAM such as RAM. The processor may read instructions from the RAM and perform actions as instructed.

The computer system may further include the output device to provide at least some of the results of the execution as output including, but not limited to, visual information to users, such as external agents. The output device may include a display on computing devices and virtual reality glasses. For example, the display may be a mobile phone screen or a laptop screen. GUIs and/or text may be presented as an output on the display screen. The computer system may further include an input device to provide a user or another device with mechanisms for entering data and/or otherwise interacting with the computer system. The input device may include, for example, a keyboard, a keypad, a mouse, or a touchscreen. Each of these output devices and input devices may be joined by one or more additional peripherals. For example, the output device may be used to display the results such as bot responses by the executable chatbot.

A network communicator may be provided to connect the computer system to a network and in turn to other devices connected to the network including other clients, servers, data stores, and interfaces, for example. A network communicator may include, for example, a network adapter such as a LAN adapter or a wireless adapter. The computer system may include a data source interface to access the data source. The data source may be an information resource. As an example, a database of exceptions and rules may be provided as the data source. Moreover, knowledge repositories and curated data may be other examples of the data source.

Embodiments of the present disclosure provide secure data destruction and transfer systems with enhanced agent enclave for safeguarding stored decisions and inferences and methods thereof. The present disclosure implements a secure agent enclave and robust data destruction procedures, in turn reducing the risk of data leaks and unauthorized access. This heightened security ensures that sensitive data, including Personally Identifiable Information (PII) and other confidential data, remains confidential and secure, effectively addressing the pressing security challenges of digital age. Data integrity and compliance are paramount for organizations, particularly those dealing with sensitive and regulated data. The present disclosure enables securely erasing data and confirm its absence within the environment ensures data integrity. Moreover, the present disclosure facilitates compliance with data protection regulations, minimizing the legal and financial risks associated with data breaches and non-compliance. The present disclosure ensures that coordinators and data processors are promptly updated when a data module is removed, enabling the system to continue functioning seamlessly. This results in minimal disruptions and maintains operational continuity.

The written description describes the subject matter herein to enable any person skilled in the art to make and use the embodiments. The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

We claim:

1. A method for a secure data destruction and transfer, comprising:
selecting, by a destroy AI agent, one or more Machine Learning (ML) models amongst a plurality of ML models and data associated with the one or more ML models to be destroyed, wherein the one or more ML models and the data is stored in a datastore;
destroying, by the destroy AI agent, the one or more ML models and the data associated with the one or more ML models from the datastore;
verifying, by the destroy AI agent, a destruction of the one or more ML models and the data;
notifying, by the destroy AI agent, one or more coordinators about the destruction of one or more ML models and the data; and
adjusting, by the one or more coordinators, one or more data processing tasks performed by the one or more ML models to accommodate an absence of the one or more ML models and the data, wherein remaining data associated with the one or more data processing tasks is transmitted to one or more available data processing agents for performing the one or more data processing tasks.

2. The method according to claim 1, wherein selecting that the one or more Machine Learning (ML) models and the data associated with the one or more ML models to be deleted is based on:
receiving, by the destroy AI agent, an instruction to delete at least one ML model amongst the plurality of ML models and data associated with the at least one ML model, wherein the instruction is received from one of a hardware processor based on a predefined data retention policy and consent expirations, and a user; and
ascertaining, by the destroy AI agent, one or more of:
the one or more ML models and the data is not further needed;
one or more security measures require a removal of the one or more ML models and the data; and
an expiry of a consent to store the data.

3. The method according to claim 1, wherein destroying the one or more ML models and the data comprises:
performing, by the destroy AI agent, one or more of:
deleting the one or more ML models and the data; and
rendering the one or more ML models and the data inaccessible.

4. The method according to claim 1, wherein adjusting the one or more data processing tasks comprises:
performing, by the one or more coordinators one or more of:
redistributing the one or more data processing tasks amongst the one or more available data processing agents based on a reputation score fetched from one of an internal registry, and a federated marketplace, associated with the one or more available data processing agents, wherein the remaining data associated with the one or more data processing tasks is obfuscated before being redistributed among the one or more data processing agents; and
recalibrating data analyzing processes based on available data.

5. The method according to claim 4, wherein the one or more available data processing agents is configured to execute one or more data processing tasks comprising a data analysis, an inference generation, and one or more other data-related operations.

6. The method according to claim 4, further comprising:
restricting, by the destroy AI agent, a transmission of the remaining data to the one or more authorized entities, wherein the one or more authorized entities comprises the one or more coordinators, upstream processors, and downstream processors.

7. The method according to claim 1, wherein the data comprises raw data, Personally Identifiable Information (PII) associated with a user interacting with the one or more ML models, one or more user preferences associated with the user, one or more decisions derived by the one or more ML models while interacting with the user, one or more conclusion of the interaction of the user with the one or more ML models, one or more inferences generated based on the interaction of the user with the one or more ML models, behavior of an AI agent interacting with the user, access patterns, and performance metrics of the one or more ML models.

8. The method according to claim 1, wherein the datastore is configured to timestamp the data and generate a linkage between slices of the data linking the slices with each of the ML models responsible for generation of the slice of the data.

9. The method according to claim 1, further comprising:
generating, by the destroy AI agent, a cryptographically verifiable proof of destruction upon destroying the one or more ML models and the data, wherein the. The cryptographically verifiable proof of destruction comprises a detailed manifest of each targeted data object identifier;
cryptographically hashing, by the destroy AI agent, the manifest to generate a hash, wherein the hash comprises a timestamp from a secure time source and a digital signature of the destroy AI Agent, a manifest of targeted data categories and identifiers, a timestamp associated with the destruction and verification of the destruction of the data, a confirmation of a destruction method deployed; and
logging, by the destroy AI agent, the cryptographically verifiable proof of destruction securely.

10. A system for a secure data destruction and transfer, comprising:
a destroy AI agent configured to:
select one or more Machine Learning (ML) models amongst a plurality of ML models and data associated with the one or more ML models to be destroyed, wherein the one or more ML models and the data is stored in a data store;
destroy the one or more ML models and the data associated with the one or more ML models from the datastore;
verify a destruction of the one or more ML models and the data; and
notify one or more coordinators about the destruction of one or more ML models and the data; and
the one or more coordinators configured to adjust one or more data processing tasks performed by the one or more ML models to accommodate an absence of the one or more ML models and the data, wherein remaining data associated with the one or more data processing tasks is transmitted to one or more available data processing agents for performing the one or more data processing tasks.

11. The system according to claim 10, wherein the destroy AI agent is configured to select the one or more Machine Learning (ML) models and the data associated with the one or more ML models to be deleted by:
receiving an instruction to delete at least one ML model amongst the plurality of ML models and data associated with the at least one ML model, wherein the instruction is received from one of a hardware processor based on a predefined data retention policy and consent expirations, and a user; and
ascertaining one or more of:
the one or more ML models and the data is not further needed;
one or more security measures require a removal of the one or more ML models and the data; and
an expiry of a consent to store the data.

12. The system according to claim 10, wherein the destroy AI agent is configured to destroy the one or more ML models and the data by:
Performing one or more of:
deleting the one or more ML models and the data; and
rendering the one or more ML models and the data inaccessible.

13. The system according to claim 10, wherein the one or more coordinators is configured to adjust the one or more data processing tasks by:
performing one or more of:
redistributing the one or more data processing tasks amongst the one or more available data processing agents based on a reputation score fetched from one of an internal registry, and a federated marketplace, associated with the one or more available data processing agents, wherein the remaining data associated with the one or more data processing tasks is obfuscated before being redistributed among the one or more data processing agents; and
recalibrating data analyzing processes based on available data.

14. The system according to claim 13, wherein the one or more available data processing agents is configured to execute one or more data processing tasks comprising a data analysis, an inference generation, and one or more other data-related operations.

15. The system according to claim 13, wherein the destroy AI agent is configured to:
restrict a transmission of the remaining data to the one or more authorized entities, wherein the one or more authorized entities comprises the one or more coordinators, upstream processors, and downstream processors.

16. The system according to claim 10, wherein the data comprises raw data, Personally Identifiable Information (PII) associated with a user interacting with the one or more ML models, one or more user preferences associated with the user, one or more decisions derived by the one or more ML models while interacting with the user, one or more conclusion of the interaction of the user with the one or more ML models, one or more inferences generated based on the interaction of the user with the one or more ML models, behavior of an AI agent interacting with the user, access patterns, and performance metrics of the one or more ML models.

17. The system according to claim 10, wherein the datastore is configured to timestamp the data and generate a linkage between slices of the data linking the slices with each of the ML models responsible for generation of the slice of the data.

18. The system according to claim 10, wherein the destroy AI agent is configured to:
generate a cryptographically verifiable proof of destruction upon destroying the one or more ML models and the data, wherein the. The cryptographically verifiable proof of destruction comprises a detailed manifest of each targeted data object identifier;
cryptographically hash the manifest to generate a hash, wherein the hash comprises a timestamp from a secure time source and a digital signature of the Destroy AI Agent, a manifest of targeted data categories and identifiers, a timestamp associated with the destruction and verification of the destruction of the data, a confirmation of a destruction method deployed; and
log the cryptographically verifiable proof of destruction securely.

19. A non-transitory machine-readable medium including data, which when used by a system for a secure data destruction and transfer, causes the system to perform instructions that cause the system to perform operations comprising:
selecting, by a destroy AI agent, one or more Machine Learning (ML) models amongst a plurality of ML models and data associated with the one or more ML models to be destroyed, wherein the one or more ML models and the data is stored in a datastore;
destroying, by the destroy AI agent, the one or more ML models and the data associated with the one or more ML models from the datastore;
verifying, by the destroy AI agent, a destruction of the one or more ML models and the data;
notifying, by the destroy AI agent, one or more coordinators about the destruction of one or more ML models and the data; and
adjusting, by the one or more coordinators, one or more data processing tasks performed by the one or more ML models to accommodate an absence of the one or more ML models and the data, wherein remaining data associated with the one or more data processing tasks is transmitted to one or more available data processing agents for performing the one or more data processing tasks.
